(19) United States
(12) Patent Application Publication
(10) Pub. No.: US 2026/0177500 A1
(43) Pub. Date: Jun. 25, 2026

(54) Feature Prediction Using Nondestructive Workpiece Imaging

(71) Applicant: Wolfspeed, Inc., Durham, NC (US)

(72) Inventors: Matthew David Conrad, Cary, NC (US); Sumit Athikavil Suresh, Durham, NC (US); Ramya Lakshmi Gurunathan, Cary, NC (US); Edward Robert Van Brunt, Cary, NC (US); Jason William Leon Witry, Bahama, NC (US); Riley Chenchar Hanus, Cary, NC (US)

(21) Appl. No.: 18/988,290

(22) Filed: Dec. 19, 2024

(51) Int. Cl. G01N 21/88; G01N 21/23; G01N 21/3563; G01N 21/64

(52) U.S. Cl. CPC G01N 21/8851; G01N 21/23; G01N 21/3563; G01N 21/6489; G01N 2021/3568; G01N 2021/8864

(57) ABSTRACT

Systems and methods for inspecting semiconductor workpieces are provided. In one example, a method includes analyzing a semiconductor workpiece. The method includes obtaining a first type of nondestructive data associated with at least a portion of a semiconductor workpiece. The method also includes providing the first type of nondestructive data to an inspection model, the inspection model trained using a second type of nondestructive data. The method also includes obtaining an output from the inspection, wherein the output indicative of one or more features in the semiconductor workpiece.

### FIELD

The present disclosure relates generally to manufacturing semiconductor devices.

### BACKGROUND

Semiconductor devices can be fabricated from workpieces of semiconductor material, such as silicon, sapphire, silicon carbide (SiC), and many others. These materials exhibit many attractive electrical and thermophysical properties, making it suitable for the fabrication of workpieces or substrates for high power density solid state devices, such as power electronic, radio frequency, and optoelectronic devices. During manufacturing, these materials may have crystalline material features at multiple length scales, from workpiece-sized features down to micron-scale features or sub-micron scale features (e.g., nanometer scale features). It may be desirable to detect and characterize the features prior to device manufacturing.

### SUMMARY

Aspects and advantages of embodiments of the present disclosure will be set forth in part in the following description, or can be learned from the description, or can be learned through practice of the embodiments.

One example aspect is directed to a method of analyzing a semiconductor workpiece. The method includes obtaining a first type of nondestructive data associated with at least a portion of a semiconductor workpiece. The method includes providing the first type of nondestructive data to an inspection model, the inspection model trained using a second type of nondestructive data. The method includes obtaining an output from the inspection, the output indicative of one or more features in the semiconductor workpiece.

Another example aspect of the present disclosure is directed to a method for training a machine-learned inspection model. The method includes obtaining a first type of nondestructive data indicative of at least a portion of a semiconductor workpiece. The method includes obtaining a second type of nondestructive data indicative of at least the portion of the semiconductor workpiece. The method includes generating a segmented map based on the second type of nondestructive data, the segmented map indicative of one or more features of at least the portion of the semiconductor workpiece. The method includes aligning the segmented map with the second type of nondestructive data and the first type of nondestructive data. The method includes training a machine-learned inspection model to detect the one or more features of the portion of the semiconductor workpiece within the first type of nondestructive data using the segmented map as ground truth data.

Another example aspect of the present disclosure is directed to a system for inspection of a semiconductor workpiece. The system includes one or more imaging devices configured to capture a first type of non-destructive data of at least a portion of the semiconductor workpiece. The system includes processing circuitry configured to perform operations. The operations include obtaining the first type of nondestructive data of at least a portion of a semiconductor workpiece. The operations include providing the first type of nondestructive data to an inspection model, the inspection model trained using a second type of nondestructive data. The operations include obtaining an output from the inspection model, the output indicative of one or more features of the semiconductor workpiece.

Another example aspect of the present disclosure is directed to a method of analyzing a semiconductor workpiece. The method includes obtaining a first type of nondestructive data associated with at least a portion of a semiconductor workpiece. The method includes providing the first type of nondestructive data to an inspection model, the inspection model trained using a second type of nondestructive data. The method includes obtaining an output from the inspection model, the output being a probability map indicative of a respective location and respective feature area for each of a plurality of features in the semiconductor workpiece.

Another example aspect of the present disclosure is directed to a method of training a machine-learned inspection model. The method includes obtaining birefringence cross-polarized data indicative of at least a portion of a semiconductor workpiece. The method includes obtaining x-ray topography data indicative of at least the portion of the semiconductor workpiece. The method includes generating a segmented map based on the x-ray topography data, the segmented map indicative of one or more features of at least the portion of the semiconductor workpiece. The method includes aligning the segmented map with the x-ray topography data and the birefringence cross-polarized data. The method includes labeling the one or more features within the segmented map based on the x-ray topography data. The method includes training a machine-learned inspection model to detect the one or more features of the at least portion of the semiconductor workpiece within the birefringence cross-polarized data using labeling of the segmented map as ground truth data.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example system and process for inspecting a semiconductor workpiece according to example aspects of the present disclosure.

FIG. 2 depicts example images of a semiconductor workpiece according to example aspects of the present disclosure.

FIG. 3 depicts example training data for a machine learned model according to example aspects of the present disclosure.

FIG. 4 depicts an example training and inference pipeline according to example aspects of the present disclosure.

FIG. 5 depicts a block diagram of an example semiconductor inspection method according to example aspects of the present disclosure.

FIG. 6 depicts a block diagram of an example semiconductor inspection model training method according to example aspects of the present disclosure.

FIG. 7 depicts a block diagram of an example semiconductor inspection method according to example aspects of the present disclosure.

FIG. 8 depicts a block diagram of an example semiconductor inspection model training method according to example aspects of the present disclosure.

FIG. 9 depicts a block diagram of an example computing system that can be used to implement systems and methods according to example embodiments of the present disclosure.

FIG. 10 depicts example segmentation techniques to generate a segmented map according to example aspects of the present disclosure.

FIG. 11 depicts example images used or created during a machine learning segmentation process according to example aspects of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Power semiconductor devices are often fabricated from wide bandgap semiconductor materials, such as silicon carbide or Group III-nitride based semiconductor materials (e.g., gallium nitride). Herein, a wide bandgap semiconductor material refers to a semiconductor material having a bandgap greater than 1.40 eV. Aspects of the present disclosure are discussed with reference to silicon carbide-based semiconductor structures as wide bandgap semiconductor structures. Those of ordinary skill in the art, using the disclosures provided herein, will understand that example embodiments of the present disclosure may be used with any semiconductor material, such as other wide bandgap semiconductor materials, without deviating from the scope of the present disclosure. Example wide bandgap semiconductor materials include silicon carbide and the Group III-nitrides.

Power semiconductor devices may be fabricated using epitaxial layers formed on a semiconductor workpiece, such as a silicon carbide semiconductor wafer. Example semiconductor workpieces may include or be formed of one or more crystalline semiconductor materials, such as silicon, silicon carbide, sapphire, or other suitable materials. The semiconductor workpiece may be subjected to various fabrication processes to form semiconductor devices on the semiconductor workpiece. Examples fabrication process may include, for instance, surface processing operations (e.g., grinding, lapping, polishing), epitaxial growth processes, deposition, etching, annealing, implantation, surface treatment, and/or other processes to form semiconductor devices on the semiconductor workpiece. Example fabrication processes include both workpiece fabrication processes (e.g., fabricating semiconductor workpieces, such as silicon carbide semiconductor wafers) as well as various stages of semiconductor device fabrication on semiconductor workpieces (e.g., MOSFETs, Schottky diodes, HEMTs, IGBTs, etc.).

Aspects of the present disclosure are discussed with reference to a semiconductor workpiece that is a semiconductor wafer that includes silicon carbide (“silicon carbide semiconductor wafer”) for purposes of illustration and discussion. Those of ordinary skill in the art, using the disclosures provided herein, will understand that aspects of the present disclosure can be used with other semiconductor workpieces. Other semiconductor workpieces may include carrier substrates, ingots, boules, polycrystalline substrates, monocrystalline substrates, bulk crystalline material having a thickness of greater than about 1 mm, such as greater than about 5 mm, such as greater than about 10 mm, such as greater than about 20 mm, such as greater than about 50 mm, such as greater than about 100 mm, to 200 mm, etc. In some examples, the semiconductor workpiece includes silicon carbide crystalline material. The silicon carbide crystalline material may have a 4H crystal structure, 6H crystal structure, or other crystal structure. The semiconductor workpiece can be an on-axis workpiece (e.g., end face parallel to the (0001) plane) or an off-axis workpiece (e.g., end face non-parallel to the (0001) plane), such as a 2°, 4°, 6°, or 8° off-axis workpiece.

Aspects of the present disclosure may make reference to a surface of the silicon carbide semiconductor workpiece. In some examples, the surface of the workpiece may be, for instance, a silicon face of the workpiece. In some examples, the surface of the workpiece may be, for instance, a carbon face of the workpiece.

Crystalline material features can be introduced during the manufacturing process of the semiconductor workpiece, such as silicon carbide semiconductor workpieces. These features can range in width scale from nearly workpiece-size features to micron or sub-micron features (e.g., nanometer scale features). Example features may include crystalline material features, such as threading edge dislocations, basal plan dislocations, super screw dislocations, threading screw dislocations, K-marks, micropipes, mixed dislocations, hexagonal voids, stacking faults, scratches, other polytypes, contamination, and other features. In certain examples, the feature width is less than or equal to about 10 microns. In certain examples, the feature width is less than or equal to about 3 microns. In certain examples, the feature width is in a range of about 1 micron and 25 microns. In certain examples, the feature width is less than 1 micron, such as in a range of about 1 nanometer to about 900 nanometers. As used herein, a “feature width” refers to a smallest dimension in the positional coordinate plane in an image of the workpiece. Because of the significant variety of potential features and the range of potential sizes or lengths of features, it can be challenging to characterize and inspect the features of semiconductor workpieces at scale.

Certain metrology solutions may be able to detect features, such as individual micropipes, basal plane dislocation, scratches, etc., using high resolution semiconductor workpiece imaging (e.g., about 1 to about 10 microns per pixel). However, these types of features may not occur at random, but rather may have specific spatial distributions based on crystal growth and workpiece processing issues or anomalies. Various imaging techniques may be employed to detect features and their respective spatial distributions. Example imaging techniques may include, but are not limited to, X-Ray Topography (XRT) imaging, Birefringence Cross-Polarized imaging (BCP), and photoluminescence imaging. Some imaging techniques may provide better detection abilities than others.

With respect to photoluminescence imaging, photoluminescence imaging data may be obtained using a variety of radiation sources. Some radiation sources may provide better imaging properties than others based on conditions or intended use and, therefore, may be utilized under different circumstances. Example radiation sources for photoluminescence data may include, but are not limited to, ultraviolet radiation sources and infrared radiation sources. However, it should be appreciated that this list is not exhaustive. In practice, any form of radiation may be suitable for obtaining photoluminescence data.

Classifying and detecting feature distributions in semiconductor workpieces may provide more accurate information to accelerate crystal growth and workpiece technology process development. Furthermore, as crystal growth and semiconductor workpiece processing technologies evolve, new features and feature distributions may arise that are not adequately detected by prior techniques.

Some current techniques for classifying and detecting feature distributions can incorporate machine-learned models along with various imaging techniques to identify and classify features within semiconductor workpieces. These models may be incorporated into a production environment to serve as a quality assurance check and/or workpiece efficacy verification before continuing with further workpiece processing steps. In some examples, machine-learned models may take various imagery of a semiconductor workpiece and output a determination of a presence of features or defects and their severity.

Effectively incorporating machine learning into the classification and detection process of workpiece features requires training models with data of semiconductor workpieces containing features and defects. Current methods for training models have found success using destructive data of semiconductor workpieces. Destructive data can effectively and reliably detect one or more features, and their size, in semiconductor workpieces and is frequently chosen as ground truth data for training a feature detection machine learned model, or inspection model. However, as the name suggests, destructive data comes at the cost of destroying the workpiece from which it was obtained. While destructive data may be effective at obtaining feature related data, the resulting destruction of the workpieces is cost prohibitive to model implementation in large scale operations.

Accordingly, example aspects of the present disclosure provide systems and methods deploying machine-learned models to detect one or more features in a semiconductor workpiece using nondestructive data. For instance, systems and methods according to some example aspects of the present disclosure may obtain nondestructive data for a portion of a semiconductor workpiece and input the nondestructive data to a machine-learned model. The machine-learned model can produce an output indicative of one or more features (e.g., defects) within, or on, the semiconductor workpiece. In some instances, the output may be used to determine one or more portions of the semiconductor workpiece unsuitable for further semiconductor manufacturing or wafer processing.

In addition, example aspects of the present disclosure provide systems and methods for training machine-learned models to detect one or more features within a semiconductor workpiece using nondestructive data. Certain semiconductor imaging techniques may detect features within a semiconductor workpiece without materially altering the workpiece. Specifically, as examples, XRT imaging, BCP imaging, and photoluminescence data may identify one or more features present within a semiconductor workpiece in a nondestructive manner. Therefore, aspects of the present disclosure are directed to training machine-learned models using non-destructive data, such as BCP, XRT, photoluminescence data or other nondestructive data or images, to detect one or more features present within a semiconductor workpiece.

As used herein, an image is any two-dimensional representation of data associated with positional coordinates of a semiconductor workpiece. Data (nondestructive and destructive) that is spatially coordinated (e.g., to an x and y position of a workpiece) may be referred to as an image. In some examples, the images may be, for instance, optical surface microscopy images, photoluminescence (PL) microscopy images, cross-polarized light imaging images, and x-ray topography images, BCP images, scanning electron microscopy images, or other images.

The images may be, for instance, nondestructive and/or destructive images of the workpiece. As used herein, the terms “nondestructive data” and “nondestructive image” of a workpiece respectively refer to data and an image that have been obtained without destroying, consuming, or otherwise damaging the workpiece. In this regard, nondestructive data and nondestructive images may be obtained for a workpiece on which one or more devices may subsequently be formed. For example, a spatially coordinated PL image of an unetched silicon carbide workpiece may be referred to as a nondestructive image. In contrast, the terms “destructive data” and “destructive image” refer to data or an image of a workpiece that has been destroyed, consumed, or otherwise damaged to the point that subsequent devices may not be formed thereon. For example, any spatially coordinated image of a silicon carbide workpiece that has been etched with KOH/EOH or the like to delineate etch pits may be referred to as a destructive image. Additionally, nondestructive and destructive data and corresponding images may include one or more data signals or data channels. For example, a data signal may include a light emission characteristic from a crystalline feature analyzed through a light filter. Data signals may correspond to absorption signals and/or emission signals.

In some embodiments, XRT imaging data can provide reliable and consistent imaging of features present within a semiconductor workpiece. Specifically, XRT imaging can identify both the location and feature area of features within a workpiece due to its high resolution and granularity of detail. As used herein, “feature area” refers to the total region within a workpiece that a feature occupies. Additionally, XRT imaging can generate different data related to the same imaging target based on the reflection plane used in said imaging. For instance, in some imaging reflection planes, such as the (0008) reflection plane, XRT imaging data may identify a Burgers vector magnitude for each of the one or more features within a semiconductor workpiece. The Burgers vector magnitude may be, as an example, indicative of a severity of one or more features within the semiconductor workpiece. However, while a useful form of imaging for feature identification, XRT imaging is an incredibly costly imaging process. Therefore, implementing solely XRT imaging within a production and manufacturing environment can be cost prohibitive and resource inefficient.

Accordingly, example aspects of the present disclosure are directed toward training machine-learned models using a first type of nondestructive data, such as XRT imaging, and implementing said machine-learned model using a second type of nondestructive data. As an example, machine-learned models may be trained with a first type of nondestructive data, such as XRT imaging data, and implemented with a second type of nondestructive data, such as BCP imaging data or photoluminescence data. As examples, BCP imaging and photoluminescence data may be less cost prohibitive than XRT imaging but can identify one or more features in a semiconductor workpiece in a manner that may directly map to XRT imaging data obtained from the same workpiece.

Various types of machine-learned models may be utilized in accordance with the systems and methods of the present disclosure. As examples, deep learning networks, such as U-Net architecture deep learning networks may be trained to identify features within a semiconductor workpiece.

In some embodiments, the training process of an example machine learned inspection model may be as follows. A first type of nondestructive data, such as BCP or photoluminescence data, may be obtained from a semiconductor workpiece. In addition, a second type of nondestructive data, such as XRT data, may also be obtained. From the second type of nondestructive data, a segmented map of the workpiece may be generated identifying one or more features within the semiconductor workpiece. The segmented map may be aligned with the second type of nondestructive data and the first type of nondestructive data. Aligning the segmented map with the obtained data may ensure the locations of the one or more features identified in the segmented map align with the locations of the one or more features within the obtained data. In some examples, aligning the obtained data and the map involves scaling the map to match the size (e.g., resolution and/or dimensions) of the obtained data and translating the map to match the orientation of the obtained data. Once aligned, the segmented map may be used as ground truth data for training the machine-learned inspection model while the first type of nondestructive data is provided as input to the model.

In some embodiments, preparing the segmented map for use in training may involve labelling the one or more segmented groupings within the map as indicative of one or more features. For instance, the segmented map may be an image of groupings of pixels with different values (e.g., color values). For instance, in the example of a binary segmented map, the pixels of a first value may be indicative of a normal portion of a workpiece or absence of features, whereas the pixels of a second value may be indicative of one or more features on or within the workpiece. In some instances, groupings of pixels of the second value may indicate the location of features and the quantity of pixels in each of the groupings may indicate the severity or feature area of the features. As such, labeling the features within the binary segment map may involve labelling the groupings of pixels of the second value as features. The labeled feature data may then be used as ground truth data in training the machine learned model. Aspects of the present disclosure are discussed with reference to a binary segmented map for purposes of illustration and discussion. Those of ordinary skill in the art, using the disclosures provided herein, will understand that the segmented map may have any distribution of pixels or pixel values associated with features and may be, for instance, a ternary segmented map, a quaternary segmented map, etc.

In some embodiments, the segmented map may be multi-channel. In this respect, the segmented map may include various channels, each channel identifying a set of features via pixels of the first value and pixels of the second value.

In some embodiments, the segmented map may be multi-channel. In this respect, the segmented map may include various channels, each channel identifying a set of features via pixels of the first value and pixels of the second value. In some examples, the segmented map may identify a first set of features via pixels of a first value or first value range, a second set of features via pixels of a second value range, the third set of features via pixels of a third value range, and so forth. The segmented map may identify the absence of features via pixels of a fourth value or fourth value range. Any suitable distribution of pixel values or ranges of pixel values may be used to identify different features in the segmented map without deviating from the scope of the present disclosure.

A variety of computer vision techniques may be utilized to generate segmented maps. For instance, computer vision segmentation techniques may include, but are not limited to, blurring, background subtraction, local maxima and peak finding, thresholding, erosion, and dilations using a kernel specific to enhance or remove a feature. In addition, any number of computer vision techniques may be used in combination or alone, along with the manual removal of noisy features still present after segmentation techniques

In some embodiments, implementation and operation of an inspection model trained using nondestructive data may be as follows. A first type of nondestructive data may be obtained from a semiconductor workpiece, such as BCP data or photoluminescence data. The data may be provided to a machine-learned inspection model, the model being trained using a second type of nondestructive data. The machine-learned inspection model may then generate an output that indicates one or more features present on or within the semiconductor workpiece. In some embodiments, the output may be a probability map that indicates both a location and a feature area of one or more features of the semiconductor workpiece. As an example, the probability map may be a segmented image where groupings of pixels of a first value indicate the location and severity of one or more features and pixels of a second value indicate a lack thereof. More specifically, the segmented image may include groupings of pixels of a first value whose location within the image directly translates to a location on or within the workpiece and the quantity of pixels within each grouping indicates a feature area of the one or more features of the workpiece.

In some embodiments, the probability map may be a multi-channel probability map. In this manner, each channel of the multi-channel output may correspond to a particular defect type (e.g., K-mark, super screw dislocation, edge threading dislocation, etc,). Further, each channel may have its own corresponding probability map where pixels of the first value indicate a normal portion of a semiconductor workpiece and pixels of the second value indicate the presence of the feature associated with that particular channel of the multi-channel output.

Aspects of the present disclosure are discussed with reference to a binary probability map for purposes of illustration and discussion. Those of ordinary skill in the art, using the disclosures provided herein, will understand that the probability map may have any distribution of pixels or pixel values associated with features and may be, for instance, a ternary segmented map, a quaternary segmented map, etc. In some examples, the probability map may identify a first set of features via pixels of a first value or first value range, a second set of features via pixels of a second value range, the third set of features via pixels of a third value range, and so forth. The probability map may identify the absence of features via pixels of a fourth value or fourth value range. Any suitable distribution of pixel values or ranges of pixel values may be used to identify different features in the probability map without deviating from the scope of the present disclosure.

In some instances, portions of the groupings of pixels indicative of one or more features may be filtered from the output due to their size. For example, groupings (e.g., segments) with a quantity or area of pixels below a given threshold may be filtered from the output probability map. Further, in some embodiments, the output probability map may be used to determine one or more portions of the semiconductor workpiece to remove or that may be unusable for semiconductor manufacturing or further wafer processing.

The systems and methods disclosed herein provide for identification of a plurality of features and defects within a semiconductor workpiece. As examples, feature and defects that may be identified include, but are not limited to, threading edge dislocations, basal plane dislocations, super screw dislocations, micropipes, mixed dislocations, hexagonal voids, stacking faults, scratches, and any other features or defects within a semiconductor workpiece which may alter, effect, or disfigure the workpiece.

Additionally, the systems and methods disclosed herein may provide for identification of features and defects within a variety of different types of semiconductor workpieces. As examples, the system and methods herein may identify features or defects within silicon carbide wafers, such as 4H—SiC wafers and/or silicon carbide seeds, such as 4H—SiC seeds. As used herein “seed(s)” refers to a slice or portion of a crystalline material from which a larger mono-crystalline structure may grow. Additionally, the semiconductor workpieces may vary in size. For example, the semiconductor workpieces may include a width of about 150 mm or, in some examples, about 200 mm. It should be appreciated that this list is not exhaustive. In practice, the systems and methods disclosed herein may be performed with any type or makeup of semiconductor workpiece in which nondestructive data may identify features or defects.

Example aspects of the present disclosure can provide a number of technical effects and benefits, including improvements to computing technology and/or semiconductor fabrication technology. For instance, the use of nondestructive data in training machine learned models within the semiconductor manufacturing process may substantially decrease the cost of wafer inspection processes and satisfy the rapid manufacturing capacity expansion needed to meet the demand for several industries consuming semiconductor devices, such as the automotive industry, artificial intelligence industries, electronics industries, and similar electronics industries. The systems and methods according to the present disclosure can solve several inspection steps through the workpiece and semiconductor processes such as, for example, detection of anomalies or defects like scratches, stacking faults, super screw dislocations, and similar wafer manufacturing defects without the destruction of workpieces or the use of costly imaging processes. Although there are many scalability challenges for manual inspection processes such as training, quality control, floor space and proper feedback metrics for process development, these challenges have endured as conventional systems have lacked comparable ability to detect strange and anomalous features. Example aspects of the present disclosure, however, can provide similarity comparisons and anomaly detection with comparable performance to manual inspection without resorting to destructive data within the model training process and the use of costly imaging processing during manufacturing line implementation.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood that when an element such as a layer, structure, region, or substrate is referred to as being “on” or extending “onto” another element, it may be directly on or extend directly onto the other element or intervening elements may also be present and may be only partially on the other element. In contrast, when an element is referred to as being “directly on” or extending “directly onto” another element, there are no intervening elements present, and may be partially directly on the other element. It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present.

As used herein, a first structure “at least partially overlaps” or is “overlapping” a second structure if an axis that is perpendicular to a major surface of the first structure passes through both the first structure and the second structure. A “peripheral portion” of a structure includes regions of a structure that are closer to a perimeter of a surface of the structure relative to a geometric center of the surface of the structure. A “center portion” of the structure includes regions of the structure that are closer to a geometric center of the surface of the structure relative to a perimeter of the surface. “Generally perpendicular” means within 15 degrees of perpendicular. “Generally parallel” means within 15 degrees of parallel.

Relative terms such as “below” or “above” or “upper” or “lower” or “horizontal” or “lateral” or “vertical” may be used herein to describe a relationship of one element, layer or region to another element, layer or region as illustrated in the figures. It will be understood that these terms are intended to encompass different orientations of the device in addition to the orientation depicted in the figures.

Embodiments of the disclosure are described herein with reference to cross-section illustrations that are schematic illustrations of idealized embodiments (and intermediate structures) of the invention. The thickness of layers and regions in the drawings may be exaggerated for clarity. Additionally, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Similarly, it will be understood that variations in the dimensions are to be expected based on standard deviations in manufacturing procedures. As used herein, “approximately” or “about” includes values within 10% of the nominal value.

Like numbers refer to like elements throughout. Thus, the same or similar numbers may be described with reference to other drawings even if they are neither mentioned nor described in the corresponding drawing. Also, elements that are not denoted by reference numbers may be described with reference to other drawings.

Some embodiments of the invention are described with reference to semiconductor layers and/or regions which are characterized as having a conductivity type such as n type or p type, which refers to the majority carrier concentration in the layer and/or region. Thus, n type material has a majority equilibrium concentration of negatively charged electrons, while p type material has a majority equilibrium concentration of positively charged holes. Some material may be designated with a “+” or “−” (as in n+, n−, p+, p−, n++, n−−, p++, p−−, or the like), to indicate a relatively larger (“+”) or smaller (“−”) concentration of majority carriers compared to another layer or region. However, such notation does not imply the existence of a particular concentration of majority or minority carriers in a layer or region.

In the drawings and specification, there have been disclosed typical embodiments and, although specific terms are employed, they are used in a generic and descriptive sense only and not for purposes of limitation of the scope set forth in the following claims.

Aspects of the present disclosure are discussed with reference to input data that includes images of semiconductor workpieces. Those of ordinary skill in the art, using the disclosures provided herein, will understand that aspects of the present disclosure may be applicable to other types of data, such as other types of images, without deviating from the scope of the present disclosure.

With reference now to the Figures, example embodiments of the present disclosure will be discussed in further detail.

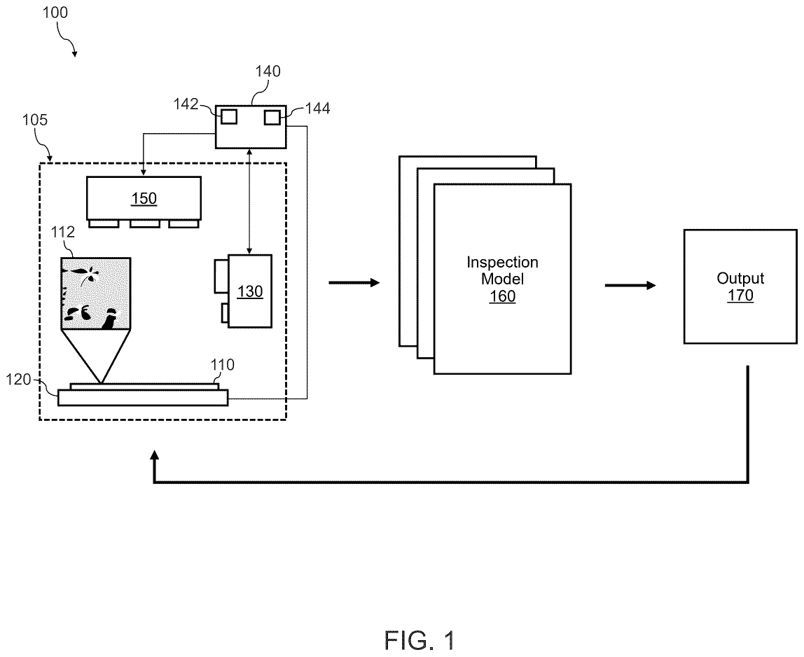

FIG. 1 depicts an example system 105 and process 100 for inspecting a semiconductor workpiece according to example aspects of the present disclosure. The example process 100 includes a semiconductor inspection system 105 configured to inspect a semiconductor workpiece 110, such as a silicon carbide semiconductor wafer or seed. Specifically, the semiconductor inspection system 105 may be configured to inspect a 4H—SiC silicon carbide wafer or seed. Those of ordinary skill in the art, using the disclosures provided herein, will understand that the system 105 may include more or fewer components without deviating from the scope of the present disclosure. The system 105 may be configured to implement one or more aspects of the present disclosure, such as the processing operations for inspecting and/or classifying of semiconductor workpieces described herein.

The system 105 can include a workpiece support 120 configured to support the semiconductor workpiece 110. The workpiece support may include a chuck (e.g., a vacuum chuck) or other workpiece holder to secure the semiconductor workpiece 110 during processing by the system 105. In some implementations, the workpiece support 120 may provide a surface on which the semiconductor workpiece 110 rests. In some implementations, the workpiece support 120 may provide for moving, rotating, angling, or otherwise reorienting the workpiece 110 relative to the system 105. In some examples, the system 105 may include a workpiece handling robot operable to move the workpiece to the workpiece support 120.

The system 105 can include one or more imaging devices 150. The imaging device(s) 150 can obtain one or more workpiece images 112 from the surface of the workpiece 110, such as workpiece image 112 (e.g., nondestructive data). The workpiece image 112 may have a resolution, which may be dependent in part on a resolution of the imaging device(s) 150. As one example, the resolution may have approximately 1 microns per pixel to about 10 microns per pixel. However, in some examples, the resolution may be less than 1 micron per pixel. The imaging device(s) 150 may include one or more imaging devices, such as one or more of a PL microscope, x-ray topographic (XRT) imaging source, cross-polarized light imaging source, birefringence cross-polarized (BCP) imaging source, camera, infrared camera, camera associated with non-visible light wavelengths, scanning electron microscope, or other suitable device configured to obtain data associated with spatial coordinates of the workpiece. In embodiments utilizing a PL microscope, or photoluminescence generally, a variety of radiation sources may be utilized. As examples, PL microscope imaging may be obtained using infrared radiation and/or ultraviolet radiation sources. Additionally, in embodiments utilizing XRT imaging, the imaging device(s) 150 may be configured to obtain XRT imaging data from a variety of reflection planes. In some examples, XRT imaging data may be obtained using a reflection plane indicative of a Burgers vector magnitude for each of the features present within workpiece 110 and workpiece images 112.

The imaging devices 150 may develop images in a variety of formats. As examples, the imaging devices 150 may capture the one or more workpiece images 112 as optical surface microscopy images, photoluminescence (PL) microscopy images, BCP light images, XRT images, or scanning electron microscopy images.

In some embodiments, the system 105 may additionally include one or more sensors 130 for obtaining data associated with the semiconductor workpiece 110, such as workpiece classification data for the semiconductor workpiece 110. Workpiece characterization data is data that provides information associated with the semiconductor workpiece 110, such as topography, roughness, presence of anomalies, doping, thickness, and/or other characteristics. Workpiece characterization data may include, for instance, an image of the surface of the workpiece 110 and/or a topological map of the surface of the workpiece 110. In some embodiments, the one or more sensors 130 may include one or more surface measurement lasers that may be operable to emit a laser onto the surface of the workpiece 110 and scan the surface (based on reflections of the laser) for depth measurements, topography measurements, etc. of the surface of the workpiece 110. Other suitable sensors may be used without deviating from the scope of the present disclosure.

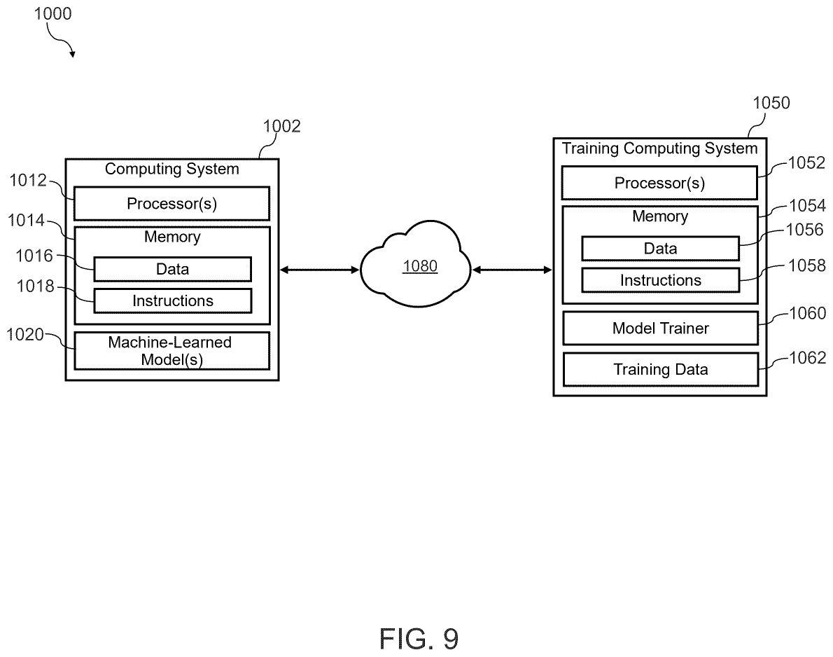

The system 105 includes one or more control devices, such as a controller 140. The controller 140 may include processing circuitry such as one or more processors 142. The controller may include one or more memory devices 144. The one or more memory devices 144 may store computer-readable instructions that when executed by the one or more processors 142 cause the one or more processors 142 to perform one or more control functions, such as any of the functions described herein. In some examples, the one or more memory devices 144 may store the inspection model 160 trained using nondestructive data. The one or more processors 142 may perform operations to provide workpiece data, such as the workpiece images 112, to the inspection model 160 within the one or more memory devices 144 and determine their output. Additionally, the controller 140 may be in communication with various other aspects of the system 105 through one or more wired and/or wireless control links. The controller 140 may send control signals to the various components of the system 105 (e.g., the workpiece support 120, the imaging device(s) 150, the sensor(s) 130, etc.) to implement the aspects of the present disclosure described herein. Additionally, the controller 140 may include one or more machine-learned models (e.g., a machine-learned encoding model, autoencoder, image translation model, feature detection model, etc.) for inspecting and/or classifying of semiconductor workpieces, as described herein. As one example, the controller 140 may be, may include, or may be in communication with at least a portion of the computing system 900 of FIG. 9 (e.g., the computing system 902 and/or the training computing system 950).

In some embodiments, the semiconductor inspection system 105 may obtain nondestructive data associated with at least a portion of the semiconductor workpiece 110 for processing by the inspection model 160. As an example, the system 105 may provide the one or more workpiece images 112 to the inspection model 160 as a first type of nondestructive data. The inspection model 160 may include a variety of machine learned models. As examples, the inspection model 160 may be, or include, neural networks, deep learning neural networks, and/or U-Net architecture neural networks trained in accordance with the example training methods and embodiments disclosed herein, each with varying capabilities to process the first type of nondestructive data. For example, the inspection model 160 may contain one or more of an autoencoder, image translation, or feature detection machine learned model or neural network trained using nondestructive data that may process the one or more workpiece images 112.

The inspection model 160 may process received nondestructive data and produce an output 170 that may include a variety of data associated with one or more characteristics of the semiconductor workpiece 110. As examples, the output 170 may be an encoding of the workpiece data, a feature detection output, or an image translation output (e.g., Birefringence Cross-Polarized imagery to X-Ray Topography imagery). Each type of output 170 may provide information relating to a plurality of characteristics pertaining to the semiconductor workpiece 110 and one or more features associated with the semiconductor workpiece 110. As depicted, in some embodiments, the output 170 may be backpropagated to the inspection system 105 and used to modify one or more semiconductor manufacturing processes based on the characteristics of one or more features present within the output 170. Although, in some embodiments, the output 170 may undergo a filtering process to eliminate potential false positives or unreliable data before being provided back to the inspection system 105.

The inspection model 160 may be trained to detect a variety of features and feature types. As examples, the inspection model 160 may be trained to detect one or more of a threading edge dislocation, basal plan dislocation, super screw dislocation, micropipe, mixed dislocation, hexagonal void, stacking fault, or scratch. Accordingly, the output 170 may be indicative of the presence of one or more of said features or feature types.

In some embodiments, the output 170 may be a feature detection output and include a probability map. The probability map may be a segmented image with segments indicating the presence of one or more features, or the high likelihood of the presence of one or more features. In some instances, said probability map may be scaled and aligned with the original workpiece images 112 such that the location of the segments within the probability map are indicative of the location of the one or more features on, or within, the semiconductor workpiece 110.

Additionally, in some examples, the segments within the probability map may be indicative of a severity of one or more features within the workpiece 110. For instance, a segment within the probability map with a large quantity of pixels may be indicative of a more severe or larger feature (e.g., feature area) whereas a segment with fewer pixels may be indicative of a less severe or smaller feature. In some embodiments, the probability map may be filtered to remove low likelihood segments. For instance, the probability map may include one or more segments with a small or relatively smaller size which may indicate a low likelihood of feature presence. As such, said one or more segments may be filtered out of the probability map entirely.

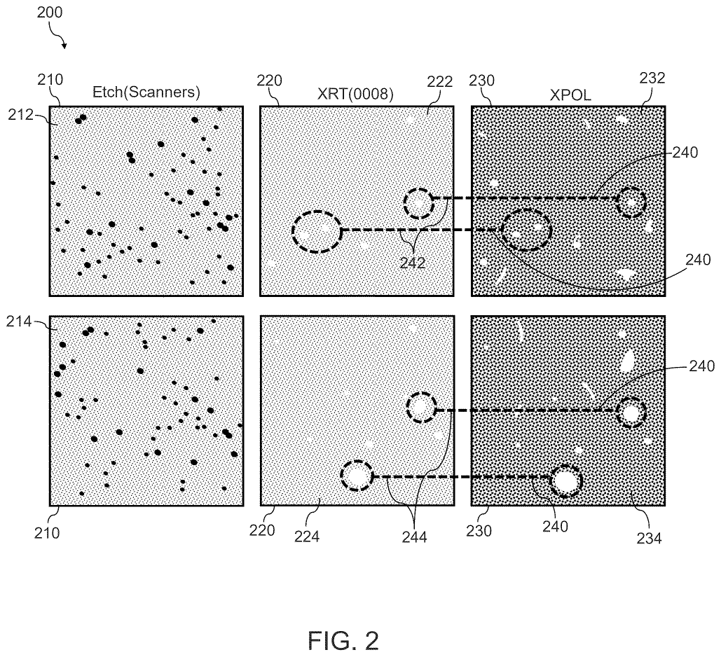

FIG. 2 depicts example images 200 of a semiconductor workpiece according to example aspects of the present disclosure. The example images 200 depict a surface of a semiconductor workpiece, such as workpiece 110 depicted in FIG. 1, with one or more features 240 present. The example images 200 are from various imaging sources as example imaging techniques for implementation of certain aspects and embodiments of the present disclosure. In practice, any forms of nondestructive imaging may be utilized. The leftmost column of images depicts etch images 210, an example of destructive data that may identify one or more features, such as features 240 in a semiconductor workpiece at the cost of materially altering the workpiece. The etch images 210 include a first etch scan 212 of a first semiconductor workpiece and a second etch scan 214 of a second semiconductor workpiece. The middle column of images includes XRT images 220 depicting one or more features 240 as a first example of nondestructive data that may be used to identify said one or more features 240. The XRT images 220 include a first XRT image 222 of the first semiconductor workpiece and a second XRT image 224 of the second semiconductor workpiece. The rightmost column of images includes BCP images 230 depicting one or more features 240 as a second example of nondestructive data that may be used to identify said one or more features 240. The BCP images 230 include a first BCP image 232 of the first semiconductor workpiece and a second BCP image 234 of the second semiconductor workpiece. The one or more features 240 depicted throughout the example images 200 include two subsets of features. First, a weak set of features 242 and, second, a strong set of features 244. As depicted in both the XRT images 220 and BCP images 230, the one or more features 240 are visually correlated with their respective strength. Stated differently, the weak set of features 242 are identifiable within first XRT image 222 and the first BCP image 232, the strong set of features 244 are identifiable within the second XRT image 224 and the second BCP image 234, and the weak set of features 242 present distinctly different than the strong set of features 244 across the XRT images 220 and the BCP images 230. Specifically, the strong set of features 244 present with a different, larger size than the weak set of features 242 across both the XRT images 220 and the BCP images 230. Turning to the first etch scan 212 and the second etch scan 214, the same property is not exhibited as with standard etch recipes the etch pits are of the relatively same size. Accordingly, utilizing nondestructive data imaging of semiconductor workpieces, such as XRT imaging and BCP imaging can provide for better identification of and distinction between weak and strong features, such as those depicted in the one or more features 240.

In some embodiments, the correlated distinction of weak and strong features between XRT imaging and BCP imaging can be utilized to train a machine learned model using a first type of nondestructive data, such as XRT imaging, and implement said machine learned model using a second type of nondestructive data, such as BCP imaging. In some examples, the machine learned model may be an image translation model, such as a conditional generative adversarial network (CGAN), and may be used to assess or demonstrate a connection between the input images an ground truth images. For instance, a connection between XRT imaging and BCP imaging. As depicted in FIG. 2, the XRT images 220 identify various features and can distinguish between weak features, such as the weak set of features 242, and strong features, such as the strong set of features 244, in a similar manner to the BCP images 230.

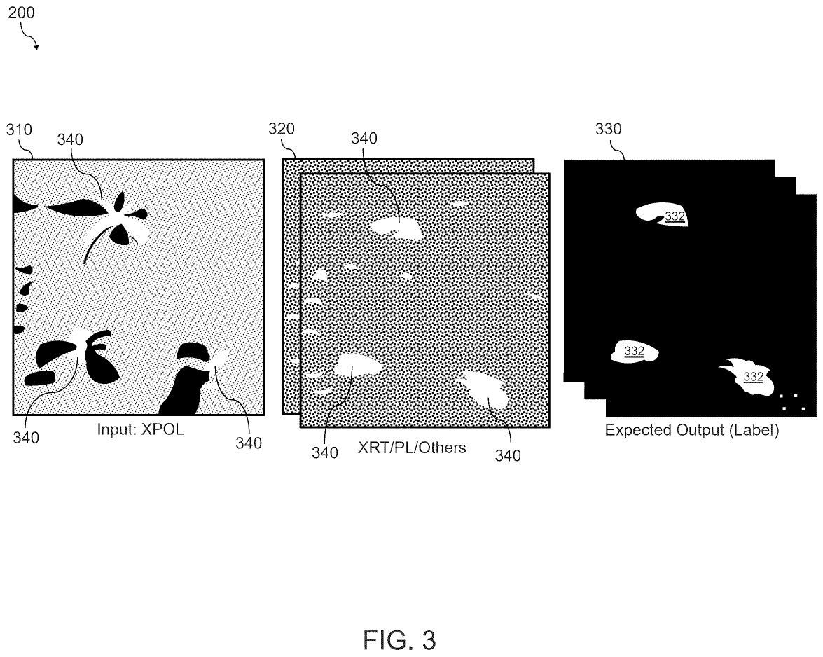

FIG. 3 depicts example training data 300 for a machine learned model according to example aspects of the present disclosure. The example training data 300 includes input data 310, ground truth data 320, and segmented ground truth data 330. The input data 310 includes a first type of nondestructive data, such as BCP image data or photoluminescence image data, indicative of a semiconductor workpiece with one or more features 340 present. The ground truth data includes a second type of nondestructive data, such as XRT image data, indicative of the same semiconductor workpiece with the same one or more features 340 present. Although, in some embodiments, the ground truth data 320 may depict a second, separate semiconductor workpiece with a second set of one or more features. Additionally, in some instances, the ground truth data 320 may undergo a transformation process such that the dimensions and resolution of said ground truth data are transformed to match that of the input data 310. Similarly, in some embodiments, the input data 310 undergoes the transformation process to align its dimensions and/or resolution with that of the ground truth data 320. The segmented ground truth data 330 includes a binary segmentation map of the ground truth data 320 with the segments 332 indicating the one or more features 340. Prior to training, the segments 332 may be labelled to indicate their representation of the one or more features 340. Additionally, in some implementations, the segmented ground truth data 330 (e.g., segmentation map) may undergo a transformation process to align the dimensions and/or resolution of the segmented ground truth data 330 with the input data 310 and the ground truth data 320. While the input data 310 and the ground truth data 320 may be two separate data types, as depicted, the one or more features 340 can be equally identifiable.

In some embodiments, the training data 300 may be used to train various machine learned models. As examples, the training data may be used to train neural networks, deep neural networks, and/or U-Net architecture neural networks. In these embodiments, the input data 310 may be used as training input while training a machine-learned model, whereas the ground truth data 320, and subsequent segmented ground truth data 330, may be provided as ground truth data. In this manner, the model being trained may learn to map the input data 310 which is of a first data type to the ground truth data 320 which is of a second data type. After training is completed, the model may take the first type of data as input, such as the input data 310 (e.g., BCP image data, PL image data), and generate an output indicative of one or more features, such as the one or more features 340, within the input data 310, without further use of the second type of data, such as the ground truth data 320 (e.g., XRT image data).

In some embodiments, the ground truth data 320 and the segmented ground truth data 330 may be multi-channel. In this manner, there may be multiple channels of ground truth data 320, with each channel linked to a particular type of defect, such as super screw dislocation, K-mark, threading edge dislocation, or any other feature or defect discussed herein. Likewise, the segmented ground truth data 330 may include multiple channels with each channel linked to a particular type of defect or particular channel of the ground truth data 320. In this manner, the segmented ground truth data 330 may identify not only the presence of defects, but also the presence of particular defects based on the channel where segments 332 may be present.

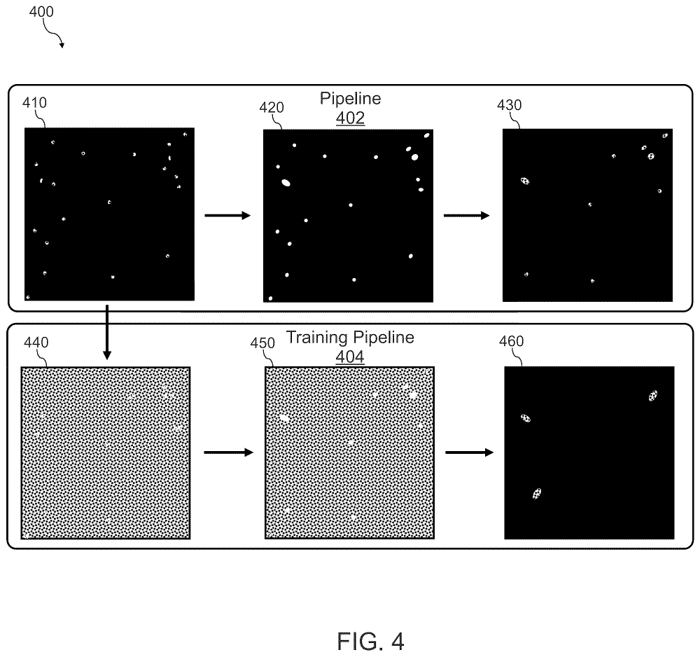

FIG. 4 depicts an example training and inference pipeline 400 according to example aspects of the present disclosure. The training and inference pipeline 400 includes an inference pipeline 402 for detecting one or more features in portions of semiconductor workpieces and a training pipeline 404 for establishing one or more machine learned models to operate within the inference pipeline 402. That is, training pipeline 404 depicts training one or more machine learned models to detect one or more features in portions of semiconductor workpieces.

The inference pipeline 402 begins with receiving input data 410. The input data can be various types of data depicting a surface or portion of a semiconductor workpiece. As examples, the input data can be a first type of nondestructive data, such as BCP image data or PL image data. To determine the presence of one or more features, the input data 410 may be provided to a trained machine learned model to generate the probability map 420.

The probability map 420 may depict one or more features present within the input data 410 and, therefore, present within a portion of a semiconductor workpiece depicted within the input data 410. Some example features that may be detected by the probability map include, but are not limited to, a threading edge dislocation, basal plan dislocation, super screw dislocation, micropipe, mixed dislocation, hexagonal void, stacking fault, or scratch. In some embodiments, and as depicted, the probability map can be a binary segmented image. The binary segmented image may include two portions of pixels, each portion with a different value. The first portion may be, for example, black and indicate a lack of features, whereas the second portion may be, for example, white and indicate the presence of one or more features. The portion of pixels indicating the presence of one or more features may be depicted in groupings as shown in the probability map 420. Each grouping may indicate the location of a feature within, or on, the semiconductor workpiece when the probability map is transposed over the input data 410. Additionally, in some embodiments, the size of each grouping or quantity of pixels in each grouping indicate the feature area of each feature. For example, the greater the quantity of pixels in a grouping may indicate a larger feature or more severe feature within the semiconductor workpiece.

In some embodiments, the inference pipeline 402 may include filtering the probability map 420 to generate a filtered probability map output 430. The probability map 420 may include a plurality of segments or other feature identifiers with a low probability of identification or negligible size. These low likelihood and/or small segments and feature identifiers may be filtered out of the probability map 420. Through this process, a filtered probability map output 430 may be obtained.

The training pipeline 404 may be utilized to train one or more machine learned models to act in accordance with the inference pipeline 402 and detect one or more features within a portion of a semiconductor workpiece. Example models that may be trained using the training pipeline 404 include, but are not limited to, machine learned models, neural networks, deep neural networks, and/or U-Net architecture neural networks.

Similar to the inference pipeline, the training pipeline 404 begins with the input data 410. As stated previously, the input data 410 may be a variety of data types and forms. As an example, the input data 410 may be a first type of nondestructive data, such as BCP imaging or PL imaging data. Along with the input data 410, the training pipeline may include obtaining a second input data of a different data type than the input data 410. As an example, the second input data may be XRT image data. The second input data may be upscaled and transformed to match the dimensions, resolution, or object placement within the input data 410 to create the aligned input data 440. The aligned input data 440 may be of a different data type than the input data 410, but depict the same or a substantially similar portion of a semiconductor workpiece. The aligned input data 440 may be input to a computer vision algorithm to generate a segmented training image 450. In some embodiments, the segmented training image 450 may be generated using a convolutional neural network (CNN) or other machine learned model. For instance, the input data 410 and/or aligned input data 440 may be provided to a machine learned model, such as a CNN, to generate the segmented training image 450. Similarly, in another embodiment, the segmented training image 450 may be generated via manual labeling.

The segmented training image 450 may identify one or more features within the aligned input data as segments. For example, the segmented training image may include pixels of a first value and a second value. The pixels of the first value may indicate a clean portion of a workpiece or lack of features, whereas the pixels of the second value may indicate the presence of one or more features in the workpiece depicted by the aligned input data 440 and input data 410. In addition, the quantity of pixels in a segment may identify a feature area or severity of a feature associated with the segment. For example, the larger a segment of pixels of the second value, the larger the feature area of the feature associated with the segment. In some embodiments, the segmented training image 450 may be labelled. Examples of this type of image can be seen in the segmented ground truth data 330 depicted in FIG. 3.

In some embodiments, the segmented training image 450 and input data 410 may be used as ground truth data and input data, respectively, to train a machine learned model to produce a probability map output 460. The probability map output 460 represents the end result output of a model trained using the training pipeline 404 and is similar to the probability map output 430 of the inference pipeline 402. In other words, the training pipeline 404 utilizes input data 410 and segmented training image 450 to create a model that may operate in accordance with the inference pipeline 402. The machine learned model may be trained through a variety of techniques to generate the probability map output 460. For instance, in some embodiments, the model may be trained using supervised learning where the feature types are determined and classified using domain knowledge, such as the training image 450. Alternatively, in some embodiments, the machine learned model may be trained using unsupervised learning techniques. In these examples, various autoencoders, clustering and dimensionality reduction techniques may be utilized to extract and determine defects within the input data 410.

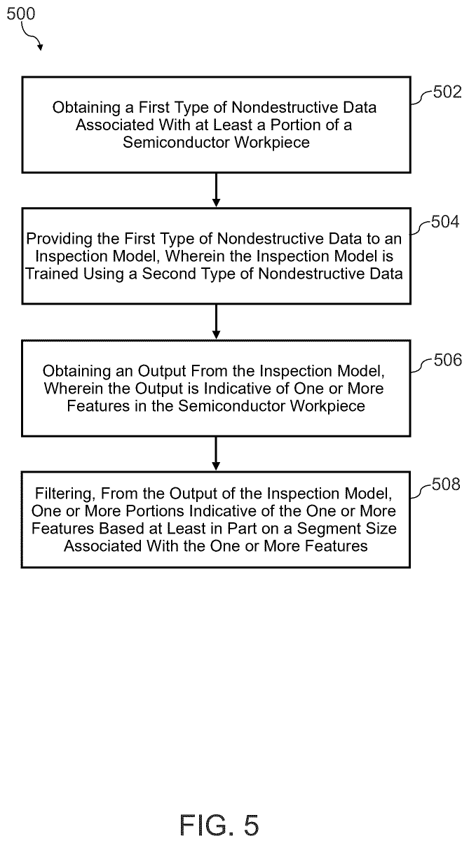

FIG. 5 depicts a block diagram of an example semiconductor inspection method 500 according to example aspects of the present disclosure. It should be appreciated that, while the steps of the inspection method 500 are provided in a particular order; in practice, the order of steps may be rearranged, added to, and/or removed from without deviating from the scope of the present disclosure. Additionally, while the steps of the method 500 may be discussed in relation to specific types of semiconductor workpieces and imaging techniques, these are solely exemplary. It would be obvious to one of skill in the art to substitute said example semiconductor workpieces and imaging techniques with various forms of semiconductor workpieces and imaging techniques known in the art.

At 502, the method 500 includes obtaining a first type of nondestructive data associated with at least a portion of a semiconductor workpiece. Various semiconductor workpieces may be utilized during the method 500 and, as examples, said semiconductor workpieces may include silicon carbide wafers, such as 4H—SiC wafers and silicon carbide seeds, such as 4H—SiC seeds. Additionally, various types of nondestructive data may be obtained as the first type of nondestructive data. For example, the first type of nondestructive data may be Birefringence Cross-Polarized (BCP) data or photoluminescence (PL) imaging data. In embodiments where PL imaging data is obtained, various radiation sources may be utilized to obtain said PL imaging data. For instance, as examples, infrared radiation sources and ultraviolet radiation sources may be implemented to obtain PL imaging data.

At 504, the method 500 includes providing the first type of nondestructive data to an inspection model, the inspection model being trained using a second type of nondestructive data. The inspection model may be one of various types of machine-learned models. For example, the inspection model may be a deep learning neural network or a U-Net architecture neural network. In some embodiments, the second type of nondestructive data may be different than the first type of nondestructive data. For instance, in some embodiments, the first type of nondestructive data may be BCP data or PL imaging data whereas the second type of nondestructive data is X-Ray Topography (XRT) imaging data. Additionally, in some embodiments, the second type of nondestructive data may be indicative of one or more features of, or on, a semiconductor workpiece and may further be indicative of a Burgers vector magnitude for each of the said one or more features. In some embodiments, the inspection model may be further trained using a segmentation map indicative of one or more features on a second semiconductor workpiece. Although, in some instances, the second semiconductor workpiece may be the same workpiece as the first workpiece. In some instances, the segmentation map may be used as ground truth data for training the inspection model. In some embodiments, the segmentation map may be aligned with the first type of nondestructive data and the second type of nondestructive data.

At 506, the method 500 includes obtaining an output from the inspection model, the output being indicative of one or more features in the semiconductor workpiece. Various features may be depicted within the output. As examples, features that may be depicted include one or more of a threading edge dislocation, basal plan dislocation, super screw dislocation, micropipe, mixed dislocation, hexagonal void, stacking fault, or scratch. Additionally, the output may take various forms. For instance, in some embodiments, the output may be a probability map. The probability map may indicate the likelihood of the presence of one or more features within the first type of nondestructive data (e.g., in, or on, the semiconductor workpiece). In some embodiments, the probability map may be a segmented image. The segmented image can include a first portion of pixels of a first value and a second portion of pixels of a second value. In some instances, the second portion of pixels may be broken up into groupings and each grouping may indicate the location of one or more features on the semiconductor workpiece. Additionally, in some instances, the quantity of pixels in each grouping may indicate a feature area or severity of the one or more features. For example, the segmented image may include a grouping of seventy pixels; the grouping defined as a plurality of pixels with at least one edge neighboring another pixel of the same value. This grouping may indicate the location of a feature of substantial severity compared to another grouping with only 15 pixels in it.

In some embodiments, and as depicted at 508, the method 500 may include filtering, from the output of the inspection model, one or more portions indicative of the one or more features based at least in part on a segment size associated with the one or more features. For example, portions of the output with a low likelihood of identifying a feature or portions with a small feature area may be filtered out of the output.

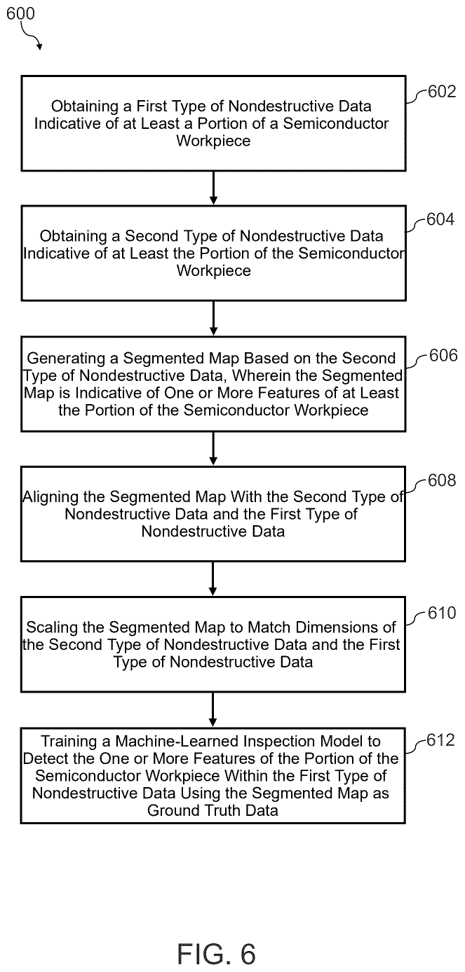

FIG. 6 depicts a block diagram of an example semiconductor inspection model training method 600 according to example aspects of the present disclosure. It should be appreciated that, while the steps of the training method 600 are provided in a particular order, in practice, the order of steps may be rearranged, added to, and/or removed from without deviating from the scope of the present disclosure. Additionally, while the steps of the method 600 may be discussed in relation to specific types of semiconductor workpieces and imaging techniques, these are solely exemplary. It would be obvious to one of skill in the art to substitute said example semiconductor workpieces and imaging techniques with various forms of semiconductor workpieces and imaging techniques known in the art.

At 602, the method 600 includes obtaining a first type of nondestructive data indicative of at least a portion of a semiconductor workpiece. Various semiconductor workpieces may be utilized during the method 600 and, as examples, said semiconductor workpieces may include silicon carbide wafers, such as 4H—SiC wafers and silicon carbide seeds, such as 4H—SiC seeds. Additionally, various types of nondestructive data may be obtained as the first type of nondestructive data. For example, the first type of nondestructive data may be Birefringence Cross-Polarized (BCP) data or photoluminescence (PL) imaging data. In embodiments where PL imaging data is obtained, various radiation sources may be utilized to obtain said PL imaging data. For instance, as examples, infrared radiation sources and ultraviolet radiation sources may be implemented to obtain PL imaging data.

At 604, the method 600 includes obtaining a second type of nondestructive data indicative of at least the portion of the semiconductor workpiece. Additionally, the second type of nondestructive data may be indicative of one or more features in the semiconductor workpiece. In some embodiments, the second type of nondestructive data may be obtained using a reflection plane indicative of a Burgers vector magnitude of each of the one or more features. The second type of nondestructive data may be a variety of nondestructive data types. For example, the second type of nondestructive data may be XRT imaging data.

At 606, the method 600 includes generating a segmented map based on the second type of nondestructive data. The segmented map may be indicative of one or more features on, or within, at least a portion of the semiconductor workpiece. For instance, as examples, the segmented map may be indicative of threading edge dislocations, basal plane dislocations, super screw dislocations, micropipes, mixed dislocations, hexagonal voids, stacking faults, or scratches. Additionally, the segmented map may take a variety of forms. In some embodiments, the segmented map may be a binary segmented image with a first portion of pixels of a first value and a second portion of pixels of a second value. The second portion of pixels may be indicative of locations of the one or more features. Further, in some embodiments, the second portion of pixels may include one or more groupings of pixels. The quantity of pixels in each of the groupings may be indicative of a feature area or severity of the feature associated with said grouping.

At 608, the method 600 includes aligning the segmented map with the second type of nondestructive data and the first type of nondestructive data. Aligning the segmented map with both types of nondestructive data may include a variety of transformations. For instance, as an example and as depicted at 610, the binary segmented map may be scaled to match the dimensions and/or resolution of the first and second types of nondestructive data.

At 612, the method 600 includes training a machine-learned inspection model to detect the one or more features of the portion of the semiconductor workpiece within the first type of nondestructive data using the segmented map as ground truth data. A variety of machine learned models may be trained using the segmented map as ground truth data. As examples, deep learning neural networks and U-Net architecture neural networks may be trained in accordance with the steps discussed within the method 600.

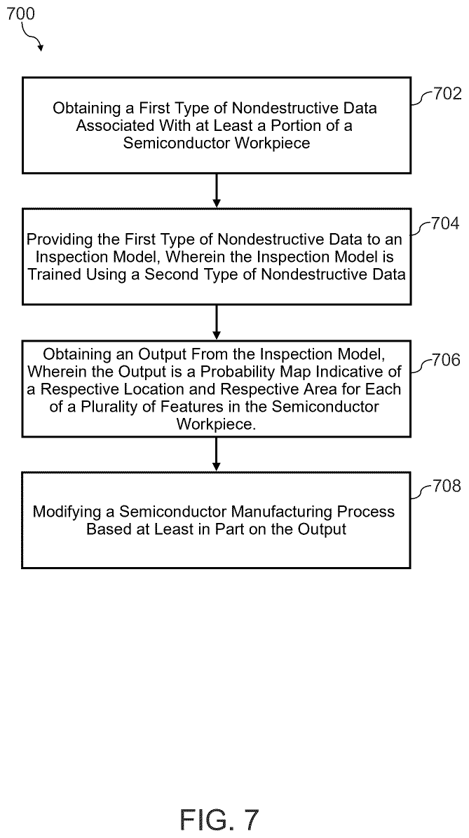

FIG. 7 depicts a block diagram of an example semiconductor inspection method 700 according to example aspects of the present disclosure. It should be appreciated that, while the steps of the inspection method 700 are provided in a particular order, in practice, the order of steps may be rearranged, added to, and/or removed from without deviating from the scope of the present disclosure. Additionally, while the steps of the method 700 may be discussed in relation to specific types of semiconductor workpieces and imaging techniques, these are solely exemplary. It would be obvious to one of skill in the art to substitute said example semiconductor workpieces and imaging techniques with various forms of semiconductor workpieces and imaging techniques known in the art.

At 702, the method 700 includes obtaining a first type of nondestructive data associated with at least a portion of a semiconductor workpiece. Various semiconductor workpieces may be utilized during the method 700 and, as examples, said semiconductor workpieces may include silicon carbide wafers, such as 4H—SiC wafers and silicon carbide seeds, such as 4H—SiC seeds. Additionally, various types of nondestructive data may be obtained as the first type of nondestructive data. For example, the first type of nondestructive data obtained may be Birefringence Cross-Polarized (BCP) data or photoluminescence (PL) imaging data. In embodiments where PL imaging data is obtained, various radiation sources may be utilized to obtain said PL imaging data. For instance, as examples, infrared radiation sources and ultraviolet radiation sources may be implemented to obtain PL imaging data.

At 704, the method 700 includes providing the first type of nondestructive data to an inspection model. The inspection model may be a variety of machine learned models trained using a second type of nondestructive data. For example, the inspection model may be a deep learning neural network or a U-Net architecture neural network trained using XRT imaging data. In some embodiments, the second type of nondestructive data may be different than the first type of nondestructive data. For instance, in some embodiments, the first type of nondestructive data may be BCP data or PL imaging data whereas the second type of nondestructive data may be XRT imaging data. Additionally, in some embodiments, the second type of nondestructive data may be indicative of one or more features of, or on, a semiconductor workpiece and may be further indicative of a Burgers vector magnitude for each of the one or more features. In some embodiments, the inspection model may be further trained using a segmentation map indicative of one or more features on a second semiconductor workpiece. Although, in some instances, the second semiconductor workpiece may be the same workpiece as the first workpiece. In some instances, the segmentation map may be used as ground truth data for training the inspection model. In some embodiments, the segmentation map may be aligned with the first type of nondestructive data and the second type of nondestructive data.

At 706, the method 700 includes obtaining an output from the inspection model, the output including a probability map indicative of a respective location and respective feature area for each of a plurality of features in the semiconductor workpiece. The probability map may indicate the likelihood of the presence of one or more features within the first type of nondestructive data (e.g., in, or on, the semiconductor workpiece). In some embodiments, the probability map may be a segmented image. The segmented image can include a first portion of pixels of a first value and a second portion of pixels of a second value. In some instances, the second portion of pixels of the second value may be broken up into groupings and each grouping may indicate the location of one or more features on a semiconductor workpiece. Additionally, in some instances, the quantity of pixels in each grouping may indicate a feature area or severity of the one or more features. For example, the segmented image may include a grouping of seventy pixels; the grouping is defined as a plurality of pixels with at least one edge neighboring another pixel of the same value. This grouping may indicate the location of one feature of substantial severity compared to another grouping with only 15 pixels in it. Additionally, various features may be depicted within the output. As examples, features that may be depicted by the output include one or more of a threading edge dislocation, basal plane dislocation, super screw dislocation, micropipe, mixed dislocation, hexagonal void, stacking fault, or scratch.

In some embodiments, and as depicted at 708, the method 700 may include modifying a semiconductor manufacturing process based at least in part on the output.

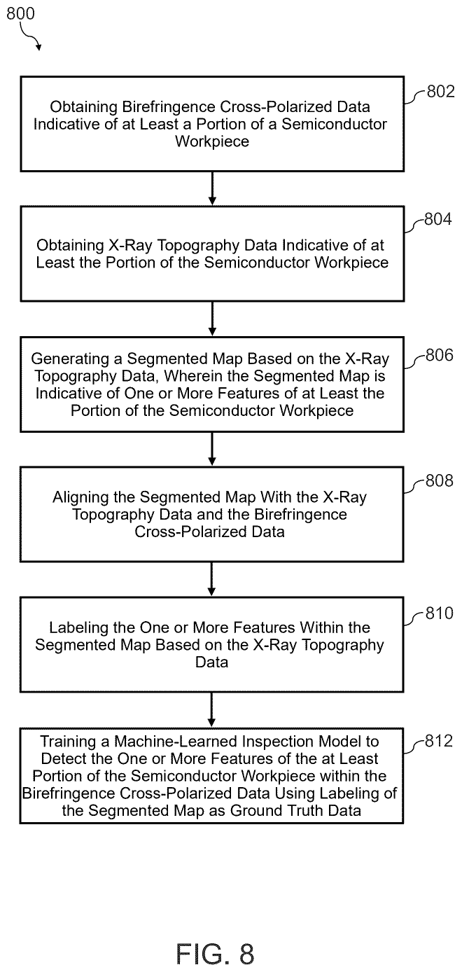

FIG. 8 depicts a block diagram of an example semiconductor inspection model training method 800 according to example aspects of the present disclosure. It should be appreciated that, while the steps of the training method 800 are provided in a particular order, in practice, the order of steps may be rearranged, added to, and/or removed from without deviating from the scope of the present disclosure. Additionally, while the steps of the method 800 may be discussed in relation to specific types of semiconductor workpieces and imaging techniques, these are solely exemplary. It would be obvious to one of skill in the art to substitute said example semiconductor workpieces and imaging techniques with various forms of semiconductor workpieces and imaging techniques known in the art.

At 802, the method 800 includes obtaining Birefringence Cross-Polarized (BCP) data indicative of at least a portion of a semiconductor workpiece. Various semiconductor workpieces may be utilized during the method 800 and, as examples, said semiconductor workpieces may include silicon carbide wafers, such as 4H—SiC wafers and silicon carbide seeds, such as 4H—SiC seeds.

At 804, the method 800 includes obtaining X-Ray Topography (XRT) data indicative of at least the portion of the semiconductor workpiece. The XRT data may be indicative of one or more features in the semiconductor workpiece. Example features may include threading edge dislocations, basal plane dislocations, super screw dislocations, micropipes, mixed dislocations, hexagonal voids, stacking faults, or scratches. Additionally, in some embodiments, the XRT data may be obtained using a reflection plane indicative of a Burgers vector magnitude of each of the one or more features.

At 806, the method 800 includes generating a segmented map based on the XRT data. The segmented map may be indicative of one or more features on, or within, at least a portion of the semiconductor workpiece. For instance, as examples, the segmented map may be indicative of threading edge dislocations, basal plane dislocations, super screw dislocations, micropipes, mixed dislocations, hexagonal voids, stacking faults, or scratches. Additionally, the segmented map may take a variety of forms. In some embodiments, the segmented map may be a binary segmented image with a first portion of pixels of a first value and a second portion of pixels of a second value. The second portion of pixels may be indicative of locations of the one or more features. Further, in some embodiments, the second portion of pixels may include one or more groupings of pixels. The quantity of pixels in each of the groupings may be indicative of a feature area or severity of the feature associated with said grouping.

At 808, the method 800 includes aligning the segmented map with the XRT data and the BCP data. Aligning the segmented map with both types of data may include a variety of transformations. For instance, as an example and as depicted at 810, the binary segmented map may be scaled to match the dimensions and/or resolution of the XRT data and the BCP data. This can include both upscaling and downscaling of the dimensions and/or resolution of the segmented map.

At 812, the method 800 includes training a machine-learned inspection model to detect the one or more features of the portion of the semiconductor workpiece within the BCP data using the segmented map as ground truth data. A variety of machine learned models may be trained using the segmented map as ground truth data. For instance, as examples, deep learning neural networks and U-Net architecture neural networks may be trained in accordance with the steps discussed within the method 800.

FIG. 9 depicts a block diagram of an example computing system 1000 that can be used to implement systems and methods according to example embodiments of the present disclosure. The system 1000 includes a computing system 1002 and a training computing system 1050 that are communicatively coupled over a network 1080.

The computing system 1002 can include any type of computing device (e.g., classical and/or quantum computing device). The computing system 1002 includes one or more processors 1012 and a memory 1014. The one or more processors 1012 can be any suitable processing device (e.g., a processor core, a microprocessor, CPU, GPU, an ASIC, a FPGA, a controller, a microcontroller, etc.) and can be one processor or a plurality of processors that are operatively connected. The memory 1014 can include one or more non-transitory computer-readable storage mediums, such as RAM, ROM, EEPROM, EPROM, flash memory devices, magnetic disks, etc., and combinations thereof. The memory 1014 can store data 1016 (e.g., parameters, input data, etc.) and instructions 1018 which are executed by the processor 1012 to cause the computing system 1002 to perform operations. In some implementations, the computing system 1002 can store or include one or more machine-learned models 1020 (e.g., autoencoders, machine-learned encoding models, etc.) as described herein.

The computing system 1002 can train the machine-learned model(s) 1020 via interaction with the training computing system 1050 that is communicatively coupled over the network 1080. The training computing system 1050 can be separate from the computing system 1002 or can be a portion of the computing system 1002.

The training computing system 1050 includes one or more processors 1052 and a memory 1054. The one or more processors 1052 can be any suitable processing device (e.g., a processor core, a microprocessor, CPU, GPU, an ASIC, a FPGA, a controller, a microcontroller, etc.) and can be one processor or a plurality of processors that are operatively connected. The memory 1054 can include one or more non-transitory computer-readable storage mediums, such as RAM, ROM, EEPROM, EPROM, flash memory devices, magnetic disks, etc., and combinations thereof. The memory 1054 can store data 1056 and instructions 1058 which are executed by the processor 1052 to cause the training computing system 1050 to perform operations. In some implementations, the training computing system 1050 includes or is otherwise implemented by one or more server computing devices.

The training computing system 1050 can include a model trainer 1060 that trains the machine-learned model(s) 1020 using various training or learning techniques, such as, for example, backwards propagation of errors. In some implementations, performing backwards propagation of errors can include performing truncated backpropagation through time. The model trainer 1060 can perform a number of generalization techniques (e.g., weight decays, dropouts, etc.) to improve the generalization capability of the models being trained.

In particular, the model trainer 1060 can train the machine-learned model(s) 1020 based on a set of training data 1062. The training data 1062 can include, for example, input data corresponding to a plurality of semiconductor workpieces workpiece images, time series data, tabular data, etc.

The model trainer 1060 includes computer logic utilized to provide desired functionality. The model trainer 1060 can be implemented in hardware, firmware, and/or software controlling a general purpose processor. For example, in some implementations, the model trainer 1060 includes program files stored on a storage device, loaded into a memory and executed by one or more processors. In other implementations, the model trainer 1060 includes one or more sets of computer-executable instructions that are stored in a tangible computer-readable storage medium such as RAM hard disk or optical or magnetic media.

The network 1080 can be any type of communications network, such as a local area network (e.g., intranet), wide area network (e.g., Internet), or some combination thereof and can include any number of wired or wireless links. In general, communication over the network 1080 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 9 illustrates one example computing system that can be used to implement example aspects of the present disclosure. Other computing systems can be used as well. For example, in some implementations, the computing system 1002 can include the model trainer 1060 and the training data 1062. In such implementations, the model(s) 1020 can be both trained and used locally at the computing system 1002.

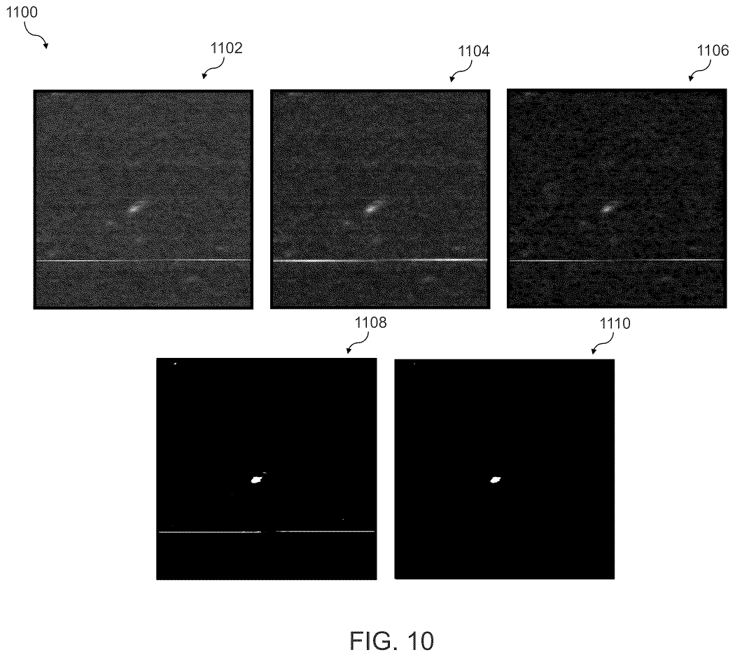

FIG. 10 depicts various segmentation techniques 1100 to generate a segmented map according to example aspects of the present disclosure. Segmented maps, such as binary segmented map 450 depicted in FIG. 4, can be generated through various techniques. In some embodiments, said binary maps may be generated using various computer vision algorithms. Depicted in FIG. 10 is a standard XRT image 1102. In some embodiments, one or more blurring algorithms may be applied to the standard XRT image 1102 and generate a blurred XRT image 1104. In some embodiments, one or more background subtraction algorithms may be applied either to the standard XRT image 1102 or blurred XRT image 1104 to generate the background subtraction image 1106. In some embodiments, one or more thresholding algorithms may be applied to either the standard XRT image 1102 or any previous XRT image, such as the blurred XRT image 1104, to generate the threshold XRT image 1108. In some embodiments, one or more erosion or dilation algorithms may be applied to the standard XRT image or any previous image, such as the threshold XRT image 1108, to generate the final segmented map 1110. It should be appreciated that the computer vision algorithms and techniques discussed herein may be used in any number of combinations or repetitions without deviating from the scope of the present disclosure. For instance, only the blurring algorithms and threshold algorithms may be utilized to generate the segmented map 1110. Alternatively, all algorithms from blurring to erosion and dilation may be used to generate the segmented map 1110.

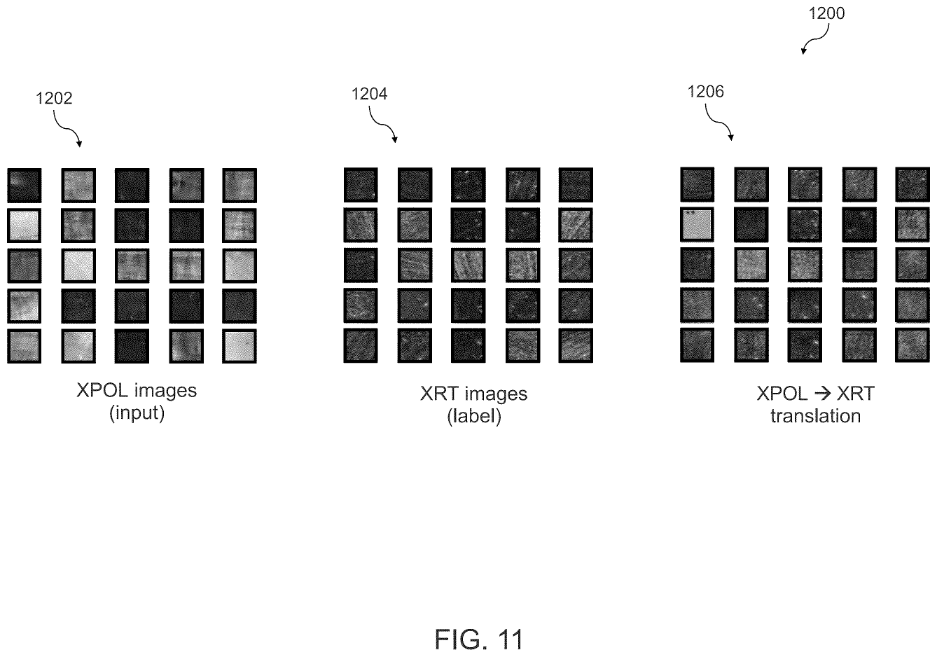

FIG. 11 depicts various images 1200 used or created during a machine learning segmentation process according to example aspects of the present disclosure. In some embodiments, a machine-learned model, such as a CNN, may be used to generate maps, such as the binary segmented map 450 depicted in FIG. 4. The machine-learned model may utilize one or more XPOL images 1202 as input and one or more XRT images 1204 as labeled training data to generate translated images 1206. The translated images 1206 may be used to identify one or more defects within a semiconductor workpiece.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

Example aspects of the present disclosure are set forth below. Any of the below features or examples may be used in combination with any of the embodiments or features provided in the present disclosure.

One example embodiment is directed to a method of analyzing a semiconductor workpiece. The method includes obtaining a first type of nondestructive data associated with at least a portion of a semiconductor workpiece. The method includes providing the first type of nondestructive data to an inspection model, the inspection model trained using a second type of nondestructive data. The method includes obtaining an output from the inspection, the output indicative of one or more features in the semiconductor workpiece.

In some embodiments, the first type of nondestructive data is birefringence cross-polarized data.

In some embodiments, the first type of nondestructive data is photoluminescence data.

In some embodiments, the photoluminescence data is generated from an ultraviolet radiation source.

In some embodiments, the photoluminescence data is generated from an infrared radiation source.

In some embodiments, the second type of nondestructive data is indicative of a second set of one or more features, and the second type of nondestructive data is obtained using a reflection plane indicative of a Burgers vector magnitude of each of the second set of one or more features.

In some embodiments, the second type of nondestructive data is x-ray topography data.

In some embodiments, the one or more features includes at least one of: a threading edge dislocation, basal plan dislocation, super screw dislocation, micropipe, mixed dislocation, hexagonal void, stacking fault, or scratch.

In some embodiments, the semiconductor workpiece is a silicon carbide wafer.

In some embodiments, the silicon carbide wafer is a 4H—SiC wafer.

In some embodiments, the semiconductor workpiece is a silicon carbide seed.

In some embodiments, the silicon carbide seed is a 4H—SiC seed.

In some embodiments, the output is a probability map.

In some embodiments, the probability map is a segmented image including: a first portion of pixels of a first value; and a second portion of pixels of a second value, the second portion of pixels indicating locations of the one or more features on the semiconductor workpiece.

In some embodiments, the second portion of pixels includes one or more groupings of pixels and a quantity of pixels in each of the one or more groupings of pixels is indicative of a severity of the one or more features.

In some embodiments, the method further includes filtering, from the output of the inspection model, one or more portions indicative of the one or more features based at least in part on a segment size associated with the one or more features.

In some embodiments, the inspection model is further trained using a segmentation map indicative of a second one or more features on a second semiconductor workpiece as ground truth data.

In some embodiments, the segmentation map is aligned with the first type of nondestructive data and the second type of nondestructive data.

In some embodiments, the inspection model is a deep learning neural network.

In some embodiments, the deep learning neural network includes a U-Net architecture.

Another example embodiment is directed to a method for training a machine-learned inspection model. The method includes obtaining a first type of nondestructive data indicative of at least a portion of a semiconductor workpiece. The method includes obtaining a second type of nondestructive data indicative of at least the portion of the semiconductor workpiece. The method includes generating a segmented map based on the second type of nondestructive data, the segmented map indicative of one or more features of at least the portion of the semiconductor workpiece. The method includes aligning the segmented map with the second type of nondestructive data and the first type of nondestructive data. The method includes training a machine-learned inspection model to detect the one or more features of the portion of the semiconductor workpiece within the first type of nondestructive data using the segmented map as ground truth data.

In some embodiments, the first type of nondestructive data is birefringence cross-polarized data.

In some embodiments, the first type of nondestructive data is photoluminescence data.

In some embodiments, the photoluminescence data is generated from an ultraviolet radiation source.

In some embodiments, the photoluminescence data is generated from an infrared radiation source.

In some embodiments, the second type of nondestructive data is indicative of one or more features, and the second type of nondestructive data is obtained using a reflection plane indicative of a Burgers vector magnitude of each of the one or more features.

In some embodiments, the second type of nondestructive data is x-ray Topography data.

In some embodiments, the one or more features includes at least one of: a threading edge dislocation, basal plane dislocation, super screw dislocation, micropipe, mixed dislocation, hexagonal void, stacking fault, or scratch.

In some embodiments, the semiconductor workpiece is a silicon carbide wafer.

In some embodiments, the silicon carbide wafer is a 4H—SiC wafer.

In some embodiments, the semiconductor workpiece is a silicon carbide seed.

In some embodiments, the silicon carbide seed is a 4H—SiC seed.

In some embodiments, aligning the segmented map with the second type of nondestructive data and the first type of nondestructive data further includes: scaling the segmented map to match dimensions of the second type of nondestructive data and the first type of nondestructive data.

In some embodiments, the machine-learned inspection model is a deep learning neural network.

In some embodiments, the deep learning neural network includes a U-Net architecture.

In some embodiments, the segmented map includes: a first portion of pixels of a first value; and a second portion of pixels of a second value, the second portion of pixels indicative of locations of the one or more features.

In some embodiments, the second portion of pixels includes one or more groupings of pixels, and a quantity of pixels in each of the one or more groupings of pixels is indicative of a severity of the one or more features.

Another example embodiment is directed to a system for inspection of a semiconductor workpiece. The system includes one or more imaging devices configured to capture a first type of non-destructive data of at least a portion of the semiconductor workpiece. The system includes processing circuitry configured to perform operations. The operations include obtaining the first type of nondestructive data of at least a portion of a semiconductor workpiece. The operations include providing the first type of nondestructive data to an inspection model, the inspection model trained using a second type of nondestructive data. The operations include obtaining an output from the inspection model, the output indicative of one or more features of the semiconductor workpiece.

In some embodiments, the first type of nondestructive data is birefringence cross-polarized data.

In some embodiments, the first type of nondestructive data is photoluminescence data.

In some embodiments, the photoluminescence data is generated from an ultraviolet radiation source.

In some embodiments, the photoluminescence data is generated from an infrared radiation source.

In some embodiments, the second type of nondestructive data is indicative of a second set of one or more features, and the second type of nondestructive data is obtained using a reflection plane indicative of a Burgers vector magnitude of each of the second set of one or more features.

In some embodiments, the second type of nondestructive data is x-ray topography data.

In some embodiments, the one or more features includes at least one of: a threading edge dislocation, basal plan dislocation, super screw dislocation, micropipe, mixed dislocation, hexagonal void, stacking fault, or scratch.

In some embodiments, the semiconductor workpiece is a silicon carbide wafer.

In some embodiments, the silicon carbide wafer is a 4H—SiC wafer.

In some embodiments, the semiconductor workpiece is a silicon carbide seed.

In some embodiments, the silicon carbide seed is a 4H—SiC seed.

In some embodiments, the output is a probability map.

In some embodiments, the probability map is a segmented image including: first portion of pixels of a first value; and a second portion of pixels of a second value, and the second portion of pixels indicates locations of the one or more features on the semiconductor workpiece.

In some embodiments, the second portion of pixels includes one or more groupings of pixels, and a quantity of pixels in each of the one or more groupings of pixels is indicative of a severity of the one or more features.

In some embodiments, the operations further include: filtering, from the output of the inspection model, one or more portions indicative of the one or more features based at least in part on a segment size associated with the one or more features.

In some embodiments, the inspection model is further trained using a segmentation map indicative of a second one or more features on a second semiconductor workpiece as ground truth data.

In some embodiments, the segmentation map is aligned with the first type of nondestructive data and the second type of nondestructive data.

In some embodiments, the inspection model is a deep learning neural network.

In some embodiments, the deep learning neural network includes a U-Net architecture.

Another example embodiment is directed to a method of analyzing a semiconductor workpiece. The method includes obtaining a first type of nondestructive data associated with at least a portion of a semiconductor workpiece. The method includes providing the first type of nondestructive data to an inspection model, the inspection model trained using a second type of nondestructive data. The method includes obtaining an output from the inspection model, the output being a probability map indicative of a respective location and respective feature area for each of a plurality of features in the semiconductor workpiece.

In some embodiments, the first type of nondestructive data is birefringence cross-polarized data.

In some embodiments, the second type of nondestructive data is x-ray Topography data.

In some embodiments, the one or more features include at least one of: a threading edge dislocation, basal plan dislocation, super screw dislocation, micropipe, mixed dislocation, hexagonal void, stacking fault, or scratch.

In some embodiments, the probability map is a segmented image including: a first portion of pixels of a first value; and a second portion of pixels of a second value, and the second portion of pixels indicates locations of the plurality of features on the semiconductor workpiece.

In some embodiments, the second portion of pixels includes one or more groupings of pixels, and a quantity of pixels in each of the one or more groupings of pixels is indicative of the feature area of each of the plurality of features and a location of each of the one or more groupings of pixels is indicative of the location of each of the plurality of features.

Another example embodiment is directed to a method of training a machine-learned inspection model. The method includes obtaining birefringence cross-polarized data indicative of at least a portion of a semiconductor workpiece. The method includes obtaining x-ray topography data indicative of at least the portion of the semiconductor workpiece. The method includes generating a segmented map based on the x-ray topography data, the segmented map indicative of one or more features of at least the portion of the semiconductor workpiece. The method includes aligning the segmented map with the x-ray topography data and the birefringence cross-polarized data. The method includes labeling the one or more features within the segmented map based on the x-ray topography data. The method includes training a machine-learned inspection model to detect the one or more features of the at least portion of the semiconductor workpiece within the birefringence cross-polarized data using labeling of the segmented map as ground truth data.

In some embodiments, the one or more features include at least one of: a threading edge dislocation, basal plan dislocation, super screw dislocation, micropipe, mixed dislocation, hexagonal void, stacking fault, or scratch.

In some embodiments, the x-ray topography data is indicative of one or more features and is obtained using a reflection plane indicative of a Burgers vector magnitude of each of the one or more features.

In some embodiments, aligning the segmented map with the x-ray topography data and the birefringence cross-polarized data further includes: scaling the segmented map to match dimensions of the x-ray topography data and the birefringence cross-polarized data.

In some embodiments, the segmented map includes: a first portion of pixels of a first value; and a second portion of pixels of a second value, the second portion of pixels are indicative of locations of the one or more features.

In some embodiments, the second portion of pixels includes one or more groupings of pixels, and a quantity of pixels in each of the one or more groupings of pixels is indicative of a severity of each of the one or more features.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method of analyzing a semiconductor workpiece, the method comprising:
obtaining a first type of nondestructive data associated with at least a portion of a semiconductor workpiece;
providing the first type of nondestructive data to an inspection model, wherein the inspection model is trained using a second type of nondestructive data; and
obtaining an output from the inspection model, wherein the output is indicative of one or more features in the semiconductor workpiece.

2. The method of claim 1, wherein the first type of nondestructive data is birefringence cross-polarized data.

3. The method of claim 1, wherein the first type of nondestructive data is photoluminescence data.

4. The method of claim 3, wherein the photoluminescence data is generated from an ultraviolet radiation source.

5. The method of claim 3, wherein the photoluminescence data is generated from an infrared radiation source.

6. The method of claim 1, wherein the second type of nondestructive data is indicative of a second set of one or more features, and wherein the second type of nondestructive data is obtained using a reflection plane indicative of a Burgers vector magnitude of each of the second set of one or more features.

7. The method of claim 1, wherein the second type of nondestructive data is x-ray topography data.

8. The method of claim 1, wherein the one or more features comprises at least one of:
a threading edge dislocation, basal plan dislocation, super screw dislocation, micropipe, mixed dislocation, hexagonal void, stacking fault, or scratch.

9. The method of claim 1, wherein the semiconductor workpiece is a silicon carbide wafer.

10. The method of claim 1, wherein the semiconductor workpiece is a silicon carbide seed.

11. The method of claim 1, wherein the output is a probability map.

12. The method of claim 11, wherein the probability map is a segmented image comprising:
a first portion of pixels of a first value; and
a second portion of pixels of a second value, wherein the second portion of pixels indicates locations of the one or more features on the semiconductor workpiece.

13. The method of claim 12, wherein the second portion of pixels comprises one or more groupings of pixels, wherein a quantity of pixels in each of the one or more groupings of pixels is indicative of a severity of the one or more features.

14. The method of claim 1, wherein the method further comprises:
filtering, from the output of the inspection model, one or more portions indicative of the one or more features based at least in part on a segment size associated with the one or more features.

15. The method of claim 1, wherein the inspection model is further trained using a segmentation map indicative of a second one or more features on a second semiconductor workpiece as ground truth data.

16. A method for training a machine-learned inspection model, the method comprising:
obtaining a first type of nondestructive data indicative of at least a portion of a semiconductor workpiece;
obtaining a second type of nondestructive data indicative of at least the portion of the semiconductor workpiece;
generating a segmented map based on the second type of nondestructive data, wherein the segmented map is indicative of one or more features of at least the portion of the semiconductor workpiece;
aligning the segmented map with the second type of nondestructive data and the first type of nondestructive data; and
training a machine-learned inspection model to detect the one or more features of the portion of the semiconductor workpiece within the first type of nondestructive data using the segmented map as ground truth data.

17. The method of claim 16, wherein the first type of nondestructive data is birefringence cross-polarized data.

18. The method of claim 16, wherein the first type of nondestructive data is photoluminescence data.

19. A system for inspection of a semiconductor workpiece, the system comprising:
one or more imaging devices configured to capture a first type of non-destructive data of at least a portion of the semiconductor workpiece;
processing circuitry configured to perform operations, the operations comprising:
obtaining the first type of nondestructive data of at least a portion of a semiconductor workpiece;
providing the first type of nondestructive data to an inspection model, wherein the inspection model is trained using a second type of nondestructive data; and
obtaining an output from the inspection model, wherein the output is indicative of one or more features of the semiconductor workpiece.

20. The system of claim 19, wherein the first type of nondestructive data is birefringence cross-polarized data, wherein the first type of nondestructive data is photoluminescence data.
